(19) United States
(12) Patent Application Publication
(10) Pub. No.: US 2016/0014550 A1
(43) Pub. Date: Jan. 14, 2016

(54) METHOD OF DYNAMICALLY MANAGING BLE COMMUNICATIONS IN WIRELESS COMMUNICATION NETWORK AND SYSTEM THEREOF

(71) Applicant: Samsung Electronics Co., Ltd., Suwon-si (KR)

(72) Inventors: Anand Sudhakar CHIDDARWAR, Bangalore (IN); Arzad Alam KHERANI, Bangalore (IN); Jitender SAJWAN, Bangalore (IN); Manoj CHOUDHARY, Bangalore (IN)

(21) Appl. No.: 14/795,241

(22) Filed: Jul. 9, 2015

(30) Foreign Application Priority Data
Jul. 9, 2014 (IN) 3398/CHE/2014

(51) Int. Cl. H04W 4/00; H04W 24/02; H04W 76/02

(52) U.S. Cl. CPC H04W 4/008; H04W 76/02; H04W 24/02; H04W 84/20

(57) ABSTRACT

The present disclosure discloses method and system for dynamically managing communications in a Bluetooth Low Energy (BLE) network. The method comprises: obtaining one or more BLE connection parameters of one or more slave devices in communication with a master device; detecting change information in the BLE network; dynamically determining one or more updated BLE connection parameters of the one or more slave devices based on the one or more BLE connection parameters and the change information; and controlling the communication between the one or more slave devices and the master device according to the dynamically determined one or more updated BLE connection parameters.

### RELATED APPLICATION

Benefit is claimed to Indian Provisional Application No. 3398/CHE/2014 titled “METHOD FOR PERFORMANCE IMPROVEMENT OF BLE SYSTEMS” filed on 9 Jul. 2014, which is herein incorporated in its entirety by reference for all purposes.

### FIELD OF THE INVENTION

The present invention generally relates to wireless communication system and more particularly relates to method and system for dynamically managing BLE communications with optimal performance under varying wireless conditions.

### BACKGROUND OF THE INVENTION

In current scenario of wireless communications, power consumption is a key factor impacting the Smart Phones in today's world. Bluetooth low energy (BLE) is ecology designed to operate with various health care and personal area network devices etc. The BLE devices are generally accessed via a centralized entity such as but not limited to smart phone.

Even within the systems using BLE, a large scope exists to reduce the current consumption, improve the capacity and performance of the existing BLE based systems.

The Link Layer BLE connection and configuration parameters exchanged during connection establishment between a master device and a slave device are rarely dynamically adapted.

This limits the optimal operating condition achievable for a BLE system. If the optimal operating conditions are not achieved it will result in less data packets being exchanged than the system can support. This will result in underutilizing the actual system. Additionally data storage requirements on the slave side and power consumption would increase due to repeated and increased wake ups for data Tx.

Further, in a BLE system having multiple slave devices connected to a BLE master device (E.g. smart phone), power consumption is not considered while selecting the connection initiation and data transfer time instances. This results in increased power consumption for the smart phone and the slave devices. The challenge lies in adjusting the operational timing parameters for multiple slaves for which master initiates connections with different connection parameters and at different time instances.

Additionally, BLE system suffers from various poor network conditions such as interference due to other network systems, congestion etc. These conditions can severely impact reliability and longevity of a BLE connection.

BLE slaves transmit data in allowed power range of (−20 dBm to +4 dBm (for 4 dBm permission needs to be taken from approval body)). But most of the BLE devices used for body/personal area networks are very close to the master BLE device. Hence, the connections do not need very high transmission power. Transmission at reduced power results both in less current consumption and less interference but these connections can be more susceptible to losses.

Therefore, there is a need for a method and system, which overcomes the challenges as mentioned above, and provides more stable and secure BLE ecosystem.

### SUMMARY

An embodiment of the present disclosure describes a method for dynamically managing communications in a Bluetooth Low Energy (BLE) network. The method comprises: obtaining one or more BLE connection parameters of one or more slave devices in communication with a master device; detecting change information in the BLE network; dynamically determining one or more updated BLE connection parameters of the one or more slave devices based on the one or more BLE connection parameters and the change information; and controlling the communication between the one or more slave devices and the master device according to the dynamically determined one or more updated BLE connection parameters.

The one or more BLE connection parameters may include the number of packet data units (PDU) to be sent in a connection interval in the BLE network, and the dynamically determining the one or more updated BLE connection parameters may comprise updating the number of PDU to be sent in a connection interval in the BLE network.

The controlling the communication may comprise disconnecting a BLE connection of an application from among a plurality of applications using the BLE network and running on the master device according to a pre-defined priority level of each of the plurality of applications.

The method may further comprises displaying a list of applications using the BLE network and running on the master device; receiving a user input for selecting an application; and disconnecting a BLE network of the selected application.

The one or more BLE connection parameters may include connection intervals of the one or more slave devices , and the dynamically determining the one or more updated BLE connection parameters may comprises analyzing the connection intervals of a first set of slave devices having established BLE communication channel with the master device, and updating the analyzed connection intervals.

The connection intervals may be updated in a way that connection trigger points for the connection intervals of a second set of slave devices attempting to establish communication channels with the master device do not overlap with the connection trigger points for the connection intervals of the first set of salve devices.

The connection intervals may be updated in a way that connection trigger points for the connection intervals have a gap of at least an inter frame spacing time (T_{IFS}).

The one or more BLE connection parameters may include information regarding at least one from among network congestion and channel interference; and the dynamically determining the one or more updated BLE connection parameters may comprise optimizing connection intervals in order to achieve one from among a reduced current consumption of power for lossy channel condition and speedy data backlog clearance for lossless channel condition.

The change information in the BLE network may include information regarding channel interference and the one or more updated BLE connection parameters include updated transmission power consumption.

Another embodiment of the present disclosure describes a device for dynamically managing communications in a Bluetooth Low Energy (BLE) network. The device operating as a master device in Bluetooth Low Energy (BLE) network may comprise communication interface and a controller configured to: obtain one or more BLE connection parameters of one or more slave devices in communication with a master device through the communication interface, detect change information in the BLE network, dynamically determine one or more updated BLE connection parameters of the one or more slave devices based on the one or more BLE connection parameters and the change information, and control the communication interface to communicate with the one or more slave devices according to the dynamically determined one or more updated BLE connection parameters.

Still another embodiment of the present disclosure describes a system for dynamically managing communications in a Bluetooth Low Energy (BLE) network. The system may comprise one or more slave devices; and one or more master devices configured to determine one or more connection parameters of the one or more slave devices, wherein the one or more master devices dynamically configures the one or more connection parameters for providing optimal performance during the wireless communication.

### BRIEF DESCRIPTION OF THE ACCOMPANING DRAWINGS

The aforementioned aspects and other features of the present invention will be explained in the following description, taken in conjunction with the accompanying drawings, wherein:

FIG. 1 illustrates a block diagram of a system for establishing BLE communications in a wireless communication network according to an embodiment of the present invention.

FIG. 2 illustrates a schematic body area network and application of BLE shaper, according to an exemplary embodiment of the present invention.

FIG. 3 illustrates a flowchart of a method of dynamically managing BLE communications in a wireless communication network, according to an embodiment of the present invention.

FIG. 4 illustrates a power aware multi-slave operational scheme, according to an embodiment of the present invention.

FIG. 5 illustrates bursty loss based dynamic adaption scheme.

FIG. 6 illustrates a method for providing optimal transmission power for data transmission between a slave device and master device, according to an embodiment of the present invention.

FIG. 7 illustrates a flowchart of a method of dynamically managing BLE communications during multi-slave device communication with a master device in a wireless communication network, according to an embodiment of the present invention.

FIG. 8 illustrated the effect of improper connection parameter selection on previous slave connections throughput.

FIG. 9 illustrates graphical representation throughput variation during multi-slave device communication with a master device for different connection intervals, according to an embodiment of the present invention.

FIG. 10 illustrates a flow chart of a method of dynamically managing BLE communications in a wireless communication network, according to an embodiment of the present invention.

### DETAILED DESCRIPTION OF THE INVENTION

The embodiments of the present disclosure will now be described in detail with reference to the accompanying drawings. However, the present disclosure is not limited to the embodiments. The present disclosure can be modified in various forms. Thus, the embodiments of the present disclosure are only provided to explain more clearly the present disclosure to the ordinarily skilled in the art of the present disclosure. In the accompanying drawings, like reference numerals are used to indicate like components.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

An embodiment of the present disclosure describes a method for dynamically configurable link layer parameter selection scheme, wherein the method comprises dynamically configuring the number of data PDU's being sent in an connection interval, and increasing the system scalability while providing desired operating conditions (such as expected delay, throughput etc.).

Another embodiment of the present disclosure describes a mathematical model for computing current consumption and expected transmission delay; allowing BLE master to intelligently select Link layer connection parameters. The chosen connection parameters are dynamically configured based on changing network conditions, reliability requirements, and channel interference etc. The embodiment enables the power sensitive master device 101 (such as smart phone, coin cell operated devices) to optimally use the battery power. This also allows the BLE devices (such as master device, slave device) to efficiently utilize the BLE device capacity (e.g. transmission of packets in an optimally spaced connection interval) while achieving a desired operating schema.

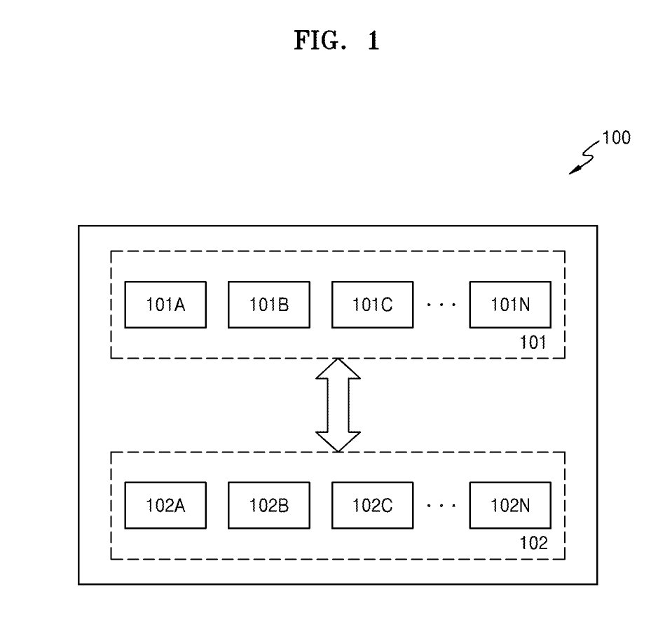

FIG. 1 illustrates a block diagram of a system 100 for dynamically managing BLE communications in a wireless communication network according to an embodiment of the present disclosure. The system 100 comprises one or more master devices 101 (such as 101A, 101B, 101C, . . . , 101N) and one or more slave devices 102 (such as 102A, 102B, 102C, . . . , 102N). The one or more master devices 101 are configured to determine one or more connection parameters of the one or more slave devices 102. Additionally, the one or more master devices 101 dynamically configure the one or more connection parameters of the one or more slave devices 102 for providing optimal performance during the wireless communication.

In one embodiment, the master device may comprise of a BLE shaper module (not shown in figure), and a BLE overload indicator (not shown in figure). The BLE shaper module enables the master device 101 to control the connection parameters dynamically to increase the capacity for handling relatively larger number BLE communication channel. The BLE overload indicator module provides input to the master device 101 on feasible combination of simultaneously active connections. Additionally, the master device 101 is also compatible to adapt and manage active BLE connections according to the interference in the wireless communication.

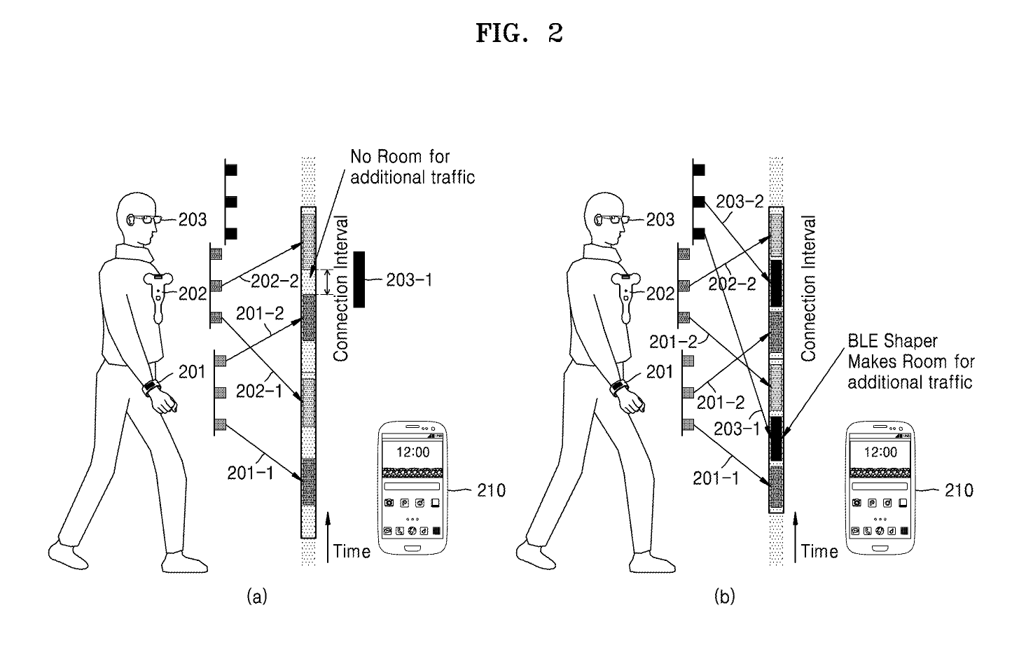

FIG. 2 illustrates a schematic body area network and application of BLE shaper (not shown in figure), according to an exemplary embodiment of the present disclosure. A body area network is an example of system 100 of FIG. 1. The body area network includes communication signals from the three devices, such as smart wrist watch 201, smart ECG (Electro Cardio Gram) device 202, and smart eye glass 203, which communicate with master device 210. According to an embodiment, BLE shaper may be an application operable in master device 210. According to another embodiment, BLE shaper may be installed an operable in any of smart wrist watch 201, smart ECG (Electro Cardio Gram) device 202, and smart eye glass 203.

In FIG. 2(a), the communication signals from the two devices (smart wrist watch 201, smart ECG device 202) have occupied the resources of the body area network, and the network does not have available resource enough to manage a communication signal from the third device (smart eye glass 203).

In FIG. 2(b), BLE shaper manages the body area network and dynamically configures the one or more connection parameter in particular link layer parameters. The re-configuration of the connection parameter enables the system 100 to accommodate additional traffic. This reconfiguration is done in a way to provide each slave 102 with the utmost necessary resources over the air time for their data transfer process to complete successfully (even considering losses incurred over the air).

In particular, in FIG. 2(a), data traffic of smart wrist watch 201 and data traffic of smart ECG device 202 occur periodically during different time slots. Specifically, data traffic of smart wrist watch 201 occurs during, for example, time slot 201-1 and time slot 201-2 while data traffic of smart ECG device 202 occurs during, for example, time slot 202-1 and time slot 202-2. When third device (smart eye glass 203) attempts to use the BLE network, the empty time slot such as a time slot between time slot 201-2 and time slot 202-2 is shorter than time slot 203-1 for data traffic of smart eye glass 203. The empty time slot may be referred to as an idle time slot, sleep time, or available resource of BLE. Such mismatch causes the BLE network's inefficiency. However, in FIG. 2(b) according to an embodiment of the present disclosure, the time slots for data traffic of smart wrist watch 201 and smart ECG device 202 are dynamically managed, so that an idle time slot between a time slot and an adjacent time slot used for smart wrist watch 201 or smart ECG device 202 may be long enough for a time slot for data traffic of smart eye glass 203. According to an embodiment, time slots for data traffic of smart wrist watch 201 or smart ECG device 202 may be moved in temporal direction. For another embodiment, such time slots may be managed to start earlier and end earlier or may be managed to start later and end later. For still another embodiment, such time slots may be managed in a way that time intervals between time slots changes to be longer or shorter.

In case re-configuration of the connection parameter does not assist in providing resources for additional BLE connection, the user is provided an option to choose the slave devices/wearable devices with which the user wishes to be in active BLE connection. In particular, master device 210 displays a list of slave devices in communication and receives a user input for selecting one from among the list. The user input may be an input for selecting slave devices to be in active BLE connection or an input for selecting salve devices to be disconnected from BLE connection. Master device 210 may comprise a display to display the list of slave devices and a user interface to receive such user input. The user input may be a touch input on the list.

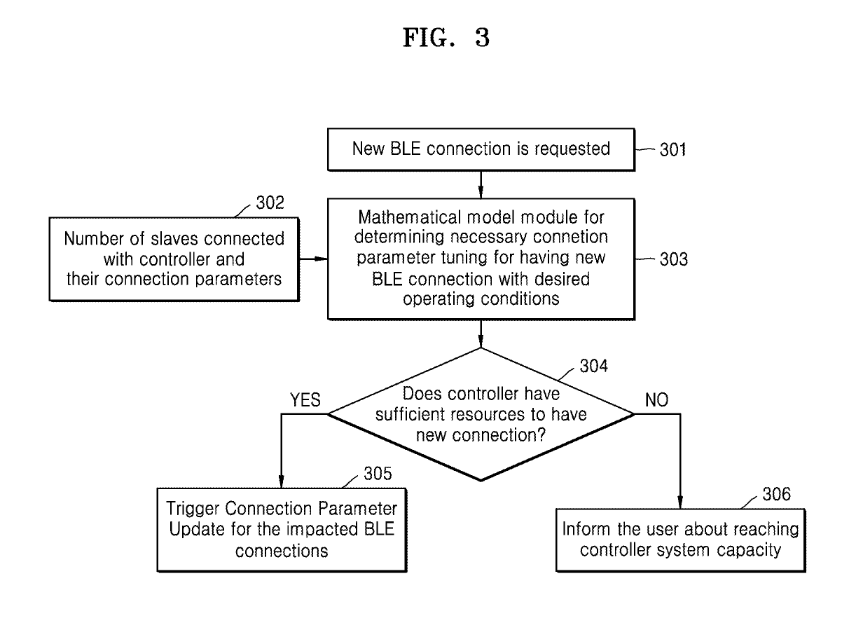

FIG. 3 illustrates a flowchart of a method of dynamically managing BLE communications in a wireless communication network, according to an embodiment of the present disclosure.

At step 301, a new BLE connection is requested by a communication device (i.e. slave device 102). Master device 101 may receive such request for a new BLE connection. Master device 101 may comprise a controller and a display, which may be implemented as hardware.

At step 302, information related to number of slaves connected with controller and their connection parameters are provided to a mathematical model module. The mathematical model module may be implemented in the controller. The connection parameters may include at least one from among information regarding time slots used for data traffic of slave devices. The information regarding time slots may include start time and end time of each of the time slots.

At step 303, the mathematical model module determines necessary connection parameter to be tuned for having new BLE connection with desired operating conditions.

At step 304, a check is performed to determine whether the controller has sufficient resources to manage new connection. The check may be performed by the controller.

If yes, at step 305, connection parameter update is triggered by the controller for the running BLE connections. If no, at step 306, the user is being informed that the controller's capacity is not enough to be used by the running BLE connections, so new connection cannot be established.

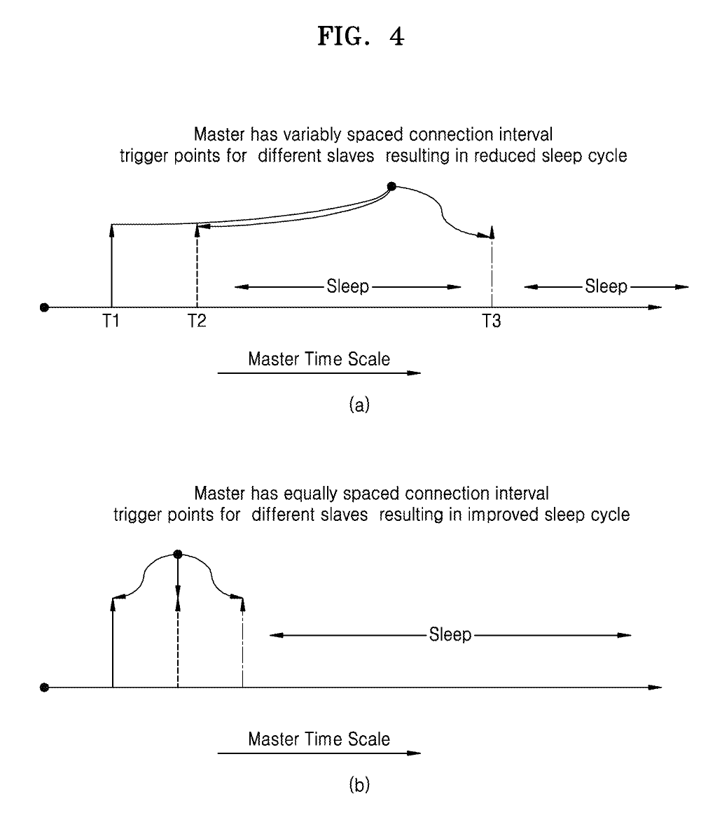

FIG. 4 illustrates a power aware multi-slave operational scheme, according to an embodiment of the present disclosure.

FIG. 4a depicts a scenario used in the prior art where the connection trigger points (such as 11, 12 & 13) are spaced at variable intervals by the master device 101 for different slave devices 102 resulting in reduced sleep cycle. Since the connection interval between the trigger points are not optimally or equally spaced, this leads to more power consumption during multi-slave communication. This also allows accommodating more slave connections when required.

FIG. 4b depicts an embodiment of the present disclosure where the connection trigger points are spaced at equal interval or spaced at optimal interval by the master device 101 for different slave devices 102 resulting in improved sleep cycle and reduced power consumption. In this embodiment, the present disclosure describes power aware multi-slave operational method for dynamically managing BLE communications in a wireless communication network. For the master device 101 having multi-slave BLE system, it is very much important to optimally use the battery power. The method disclosed in the present disclosure helps the master device 101 to align the data transmission instances for various connections in a way to reduce the device's state transitions from idle (no radio activity) state to active (transmitting or receiving data state) state while maintaining the BLE standard compliance for inter transmission intervals. The master device 101 at first analyzes the connection interval of all active slave devices 102 to avoid overlap of connection interval trigger point with the new slave device 102.

Then, the master device 101 chooses the connection interval trigger point for new slave device 102 with a gap of at least packet handling time (which includes transmitting time tx, receiving time rx, and/or processing time) from the previous trigger point. The embodiment aligns all the new connection interval trigger point using proprietary mechanism to have optimal current consumption (less radio transition) for the master device 101.

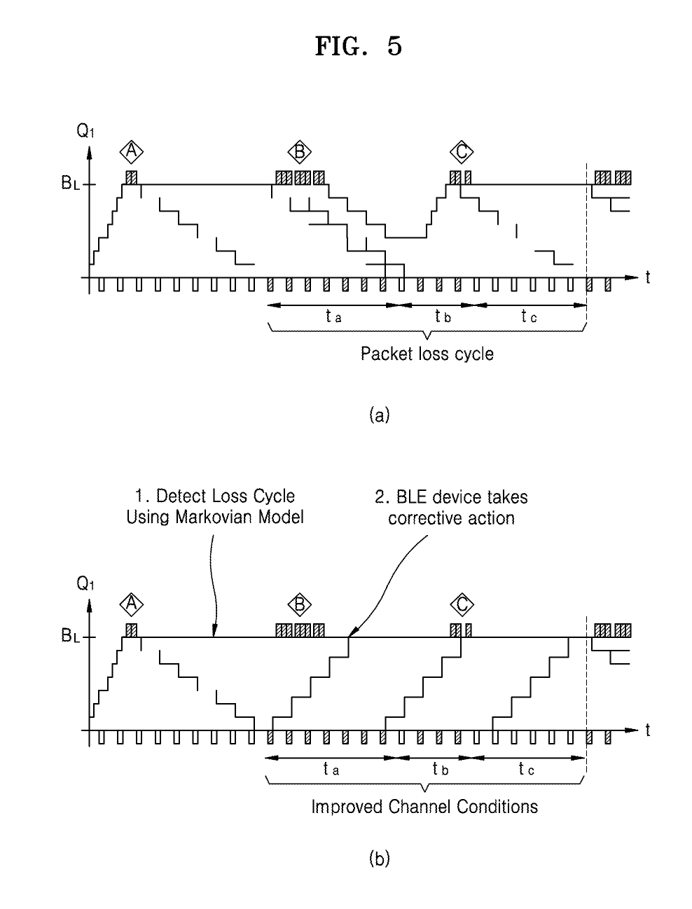

FIG. 5 illustrates bursty loss based dynamic adaption scheme.

FIG. 5a depicts a scenario of bursty loss occurring during data transfer in the prior art. Conventional BLE system suffers from various poor network conditions such as interference owing to other network systems, congestion etc. These condition in turn severely impacts reliability and longevity of BLE connection.

FIG. 5b depicts dynamic adaptation scheme according to an embodiment of the present disclosure to overcome the channel errors that occurs in bursts. The channel errors bring out the importance of increasing the connection interval value (along with aggregation) in countering these bursty losses.

Intuitively, larger connection intervals during a loss episode means reduced number of unsuccessful transmission attempts (resulting in reduced current consumption for delay tolerant applications), while a smaller connection interval during good channel helps getting the backlogged data cleared quickly. Similarly in case of critical application such as health care, transmission power of the BLE device can be increased to achieve the desired reliability and data transfer.

A standard approach to model bursty channel losses is to use a simple Markovian channel model. At point 1 of FIG. 5(b), the Markovian channel model detects loss cycle. At point 2, the master device 101/BLE device takes corrective action. Using this model at the BLE devices (such as master device 101, slave device 102), efficient transmission power control or connection parameters tuning can be performed to overcome increased current consumption (for non-critical BLE based data transfer) or improved reliability (critical health care systems need not bother about power consumption), as per application requirements.

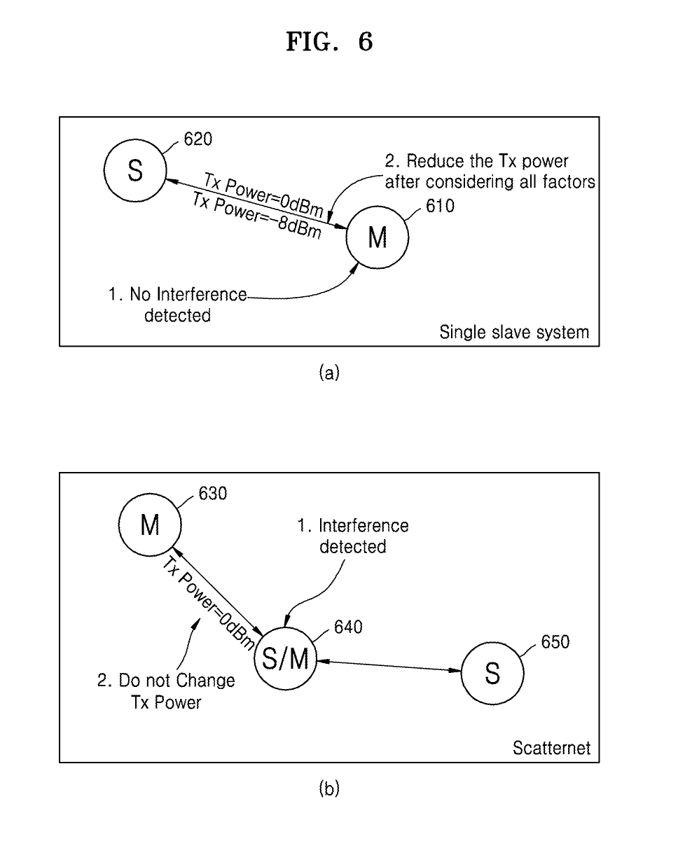

FIG. 6 illustrates a method for providing optimal transmission power for data transmission between a slave device and master device, according to an embodiment of the present disclosure. In this embodiment, the method includes detecting channel interference, detecting the channel conditions for level of interference in the channel and then using this information in determining optimal transmission power required to maintain the desired operating conditions for the connection between the slave device and the master device. Once the optimal transmission power is determined, the slave device starts transmitting the data at reduced power level.

FIG. 6a depicts an embodiment where BLE system 100 dynamically manages BLE communications between the master device and single slave device. The system 100 detects no interference and optimal channel conditions. In this case, the transmission power is reduced for data transmission from the slave device 102 to the master device 101. The master device 101 transmits data at the power of 0 dBm whereas the slave device 102 transmits/communicates at the reduced power of −8 dBm.

FIG. 6b depicts another embodiment where BLE system 100 dynamically manages BLE communications between the one or more master devices 101 and the one or more slave devices 102. The system 100 detects interference and bad channel conditions. In this case, the corrective actions are taken and appropriate transmission power is determined for smooth transmission of data from the slave device 102 to the master device 101. This method enables the BLE system 100 to reduce current consumption during transmission of data from the slave device 102 to the master device 101. Since the interference is detected during the BLE communication between the slave device 102 and the master device 101, the BLE communication occurs at an optimum power without going for reduction in power.

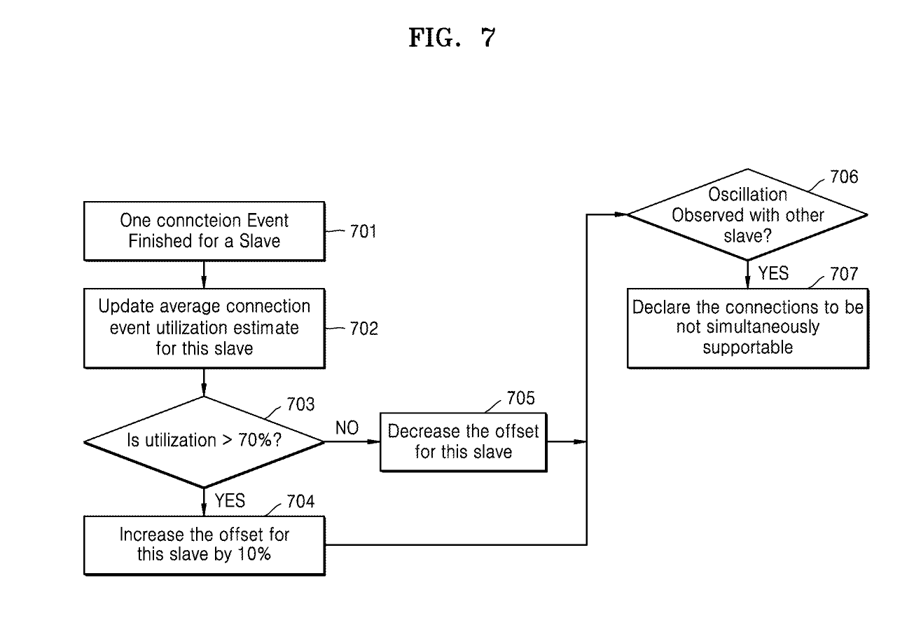

FIG. 7 illustrates a flowchart of a method of dynamically managing BLE communications during multi-slave device communication with a master device in a wireless communication network, according to an embodiment of the present disclosure. In this embodiment, the BLE communications are dynamically managed between multiple slave devices 102 and a single master device 101. At step 701, a connection event is completed for the slave device 102. At step 702, average connection event utilization is updated for the slave device 102. At step 703, a check is performed whether utilization is more than threshold level, for example, 70%. If yes, at step 704, the offset for the slave device 102 is increased by a step value, for example, 10%. (These values mentioned here are indicative and can be modified as per the application and use case requirements). If no, at step 705, the offset for the slave device 102 is decreased. At step 706, a check is performed whether the oscillation is observed with other slave device 102 due to either increase or decrease in offset. If yes, at step 707, declaration is provided to the devices (101 or 102) in BLE communication that the connections are not simultaneously supported.

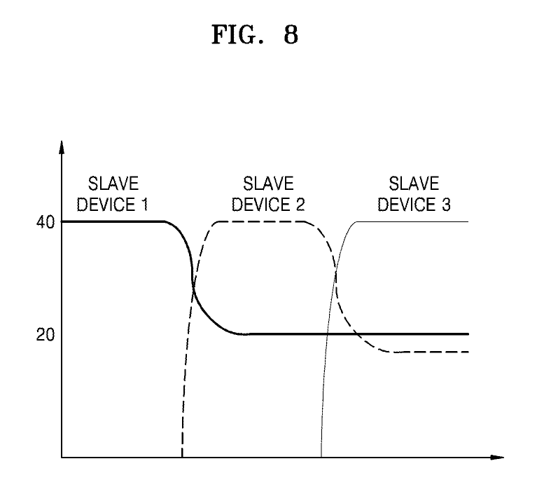

FIG. 8 illustrated the effect of improper connection parameter selection on conventional slave connections throughput in multi-slave communication. This graphs depicts that slave device 1 is running with optimum throughput at the first instance. When slave device 2 starts BLE communication then the throughput of the slave device 1 goes down. Similarly, when slave device 3 initiates the BLE communication, the throughput of the slave device 2 goes down.

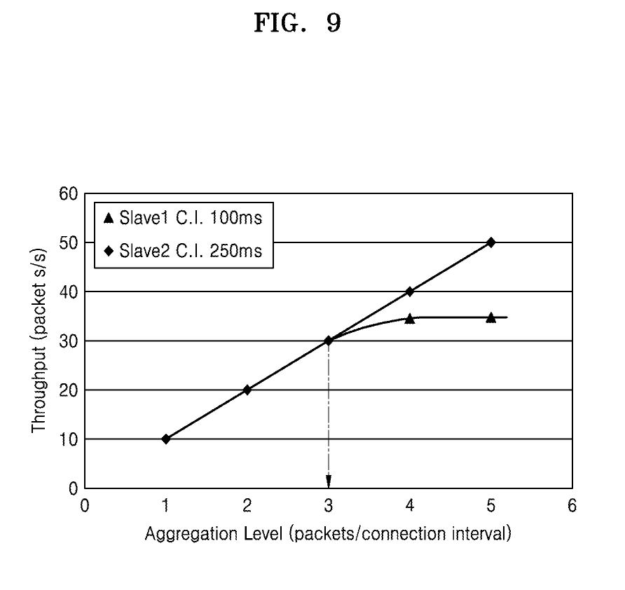

FIG. 9 illustrates graphical representation of variation of throughput during multi-slave device communications with the master device 101 for different connection intervals, according to an embodiment of the present disclosure. In this embodiment, the graph indicates the throughput obtained for the two slave devices 102 which are connected with same master device 101, as a function of the aggregation level while keeping the connection intervals for both the slave devices 102 to be same and different. It is apparent from the curve shown in the graph that the slave device 102 which gets a smaller offset between anchor point values and hence time to transmit only few packets in a connection interval (indicated by arrow), gets severely limited in throughput only because the master device 101 has allotted an anchor point without considering its traffic requirements. It is to be noted that had the master device 101 used intelligence in allocating the anchor point value for second slave device 102, the second Slave device would have gained in throughput without reduction in throughput of the first connection.

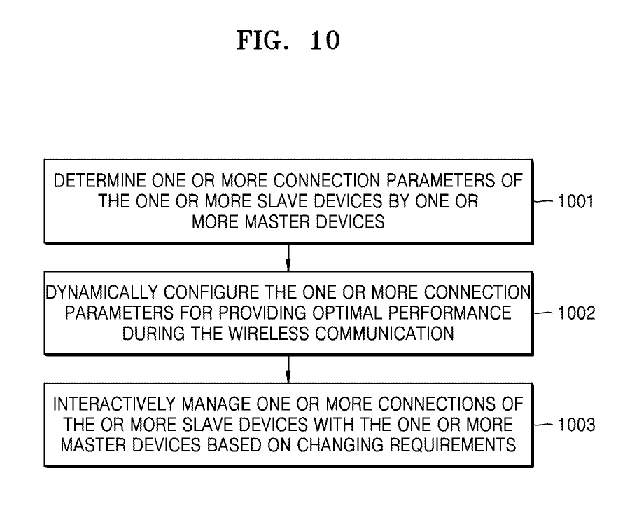

FIG. 10 illustrates a flow chart of a method of dynamically managing BLE communications in a wireless communication network, according to an embodiment of the present disclosure. At step 1001, one or more connection parameters of the one or more slave devices 102 are determined by one or more master devices 101. At step 1002, the one or more connection parameters are dynamically configured for providing optimal performance during a wireless communication. At step 1003, one or more connections of the one or more slave devices 102 with the one or more master devices 101 are interactively managed based on changing requirements.

In one embodiment, the dynamic configuration of the one or more connection parameter of the one or more slave devices comprises configuring the number of packet data units (PDU) to be sent in a connection interval.

In one embodiment, the interactively managing one or more connections comprises purging one or more applications running on the one or more master devices corresponding the one or more slave devices based on throughput requirement, pre-defined priority level to the each of the applications or user input.

The present disclosure enables a device such as smartphone, wearable etc. to intelligently configure/tune the BLE link layer parameters to the best performance tradeoffs in dynamic environment. In one exemplary embodiment, the master device such as smartphone is connected to a single slave. The smartphone dynamically changes the connection interval on observing bursty losses.

In another exemplary embodiment, the smartphone can change the connection parameters of the ongoing connections to make room/space for a new connection. For instance, if the Smartphone is connected to two BLE Slaves (say, Heart rate sensor and EEG) and user wants to attach a new sensor (say, pedometer) then, the present disclosure enables the smartphone to modify the connection intervals and offsets between anchor points of the ongoing connections to accommodate the new connection.

The present disclosure provides the following advantages:
The master device 101 (such as Smart phone) has a reliable mathematical modeling scheme to fine tune the BLE system configuration parameters to achieve the scalable, power aware, delay sensitive BLE network.
Maintaining multiple BLE connections for the master device 101 (such as smart phone), while achieving reduced current consumption for given application delay and reliability requirements.
Allows reconfiguring the existing connection's data transmission offset selection and connection interval parameters to accommodate new BLE connection/s.
Provides to the user of the master device 101 (such as smart phone) to choose the needed BLE connections in case the system reaches its capacity.
Efficiently controls the master device 101 (Smart phone) sleep and wake-up timings to reduce power consumption while maintaining the desired operating conditions.
Improves security for Master Channel MAP negotiation.
Enables a channel interference aware power transmission for critical applications which requires reliable transmission data transfer media.

Although the disclosure of method and system for dynamically managing BLE communications in a wireless communication network has been described in connection with the embodiments of the present disclosure illustrated in the accompanying drawings, it is not limited thereto. It will be apparent to those skilled in the art that various substitutions, modifications and changes may be made thereto without departing from the scope and spirit of the disclosure.

We claim:

1. A method of dynamically managing communications in a Bluetooth Low Energy (BLE) network, the method comprising:
obtaining one or more BLE connection parameters of one or more slave devices in communication with a master device;
detecting change information in the BLE network;
dynamically determining one or more updated BLE connection parameters of the one or more slave devices based on the one or more BLE connection parameters and the change information; and
controlling the communication between the one or more slave devices and the master device according to the dynamically determined one or more updated BLE connection parameters.

2. The method as claimed in claim 1,
wherein the one or more BLE connection parameters include the number of packet data units (PDU) to be sent in a connection interval in the BLE network, and
wherein the dynamically determining the one or more updated BLE connection parameters comprises updating the number of PDU to be sent in a connection interval in the BLE network.

3. The method as claimed in claim 1,
wherein controlling the communication comprises disconnecting a BLE connection of an application from among a plurality of applications using the BLE network and running on the master device according to a pre-defined priority level of each of the plurality of applications.

4. The method as claimed in claim 1, further comprising:
displaying a list of applications using the BLE network and running on the master device;
receiving a user input for selecting an application; and
disconnecting a BLE network of the selected application.

5. The method as claimed in claim 1,
wherein the one or more BLE connection parameters include connection intervals of the one or more slave devices , and
wherein the dynamically determining the one or more updated BLE connection parameters comprises:
analyzing the connection intervals of a first set of slave devices having established BLE communication channel with the master device, and updating the analyzed connection intervals.

6. The method as claimed in claim 5,
wherein the connection intervals are updated in a way that connection trigger points for the connection intervals of a second set of slave devices attempting to establish communication channels with the master device do not overlap with the connection trigger points for the connection intervals of the first set of salve devices.

7. The method as claimed in claim 5,
wherein the connection intervals are updated in a way that connection trigger points for the connection intervals have a gap of at least an inter frame spacing time (T_{IFS}).

8. The method as claimed in claim 1,
wherein the one or more BLE connection parameters include information regarding at least one from among network congestion and channel interference; and
the dynamically determining the one or more updated BLE connection parameters comprises optimizing connection intervals in order to achieve one from among a reduced current consumption of power for lossy channel condition and speedy data backlog clearance for lossless channel condition.

9. The method as claimed in claim 1,
wherein the change information in the BLE network includes information regarding channel interference and the one or more updated BLE connection parameters include updated transmission power consumption.

10. A device operating as a master device in Bluetooth Low Energy (BLE) network, the device comprising:
communication interface; and
a controller configured to:
obtain one or more BLE connection parameters of one or more slave devices in communication with a master device through the communication interface,
detect change information in the BLE network,
dynamically determine one or more updated BLE connection parameters of the one or more slave devices based on the one or more BLE connection parameters and the change information, and
control the communication interface to communicate with the one or more slave devices according to the dynamically determined one or more updated BLE connection parameters.

11. The device as claimed in claim 10,
wherein the one or more BLE connection parameters include the number of packet data units (PDU) to be sent in a connection interval in the BLE network, and
wherein the controller is further configured to update the number of PDU to be sent in a connection interval in the BLE network.

12. The device as claimed in claim 10,
wherein the controller is further configured to disconnect a BLE connection of an application from among a plurality of applications using the BLE network and running on the master device according to a pre-defined priority level of each of the plurality of applications.

13. The device as claimed in claim 10, further comprising:
a display configured to display a list of applications using the BLE network and running on the master device;
a user interface configured to receive a user input for selecting an application; and
wherein the controller is further configured to disconnect a BLE network of the selected application.

14. The device as claimed in claim 10,
wherein the one or more BLE connection parameters include connection intervals of the one or more slave devices , and
wherein the controller is further configured to analyze the connection intervals of a first set of slave devices having established BLE communication channel with the master device, and update the analyzed connection intervals.

15. The device as claimed in claim 14,
wherein the connection intervals are updated in a way that connection trigger points for the connection intervals of a second set of slave devices attempting to establish communication channels with the master device do not overlap with the connection trigger points for the connection intervals of the first set of salve devices.

16. The device as claimed in claim 14,
wherein the connection intervals are updated in a way that connection trigger points for the connection intervals have a gap of at least an inter frame spacing time (T_{IFS}).

17. The device as claimed in claim 10,
wherein the one or more BLE connection parameters include information regarding at least one from among network congestion and channel interference; and
wherein the controller is further configured to optimize connection intervals in order to achieve one from among a reduced current consumption of power for lossy channel condition and speedy data backlog clearance for lossless channel condition.

18. The device as claimed in claim 10,
wherein the change information in the BLE network includes information regarding channel interference and the one or more updated BLE connection parameters include updated transmission power consumption.

19. A system for establishing BLE communications in a wireless communication network, the system comprising:
one or more slave devices; and
one or more master devices configured to determine one or more connection parameters of the one or more slave devices,
wherein the one or more master devices dynamically configures the one or more connection parameters for providing optimal performance during the wireless communication.
